(19) United States
(12) Patent Application Publication
(10) Pub. No.: US 2014/0197557 A1
(43) Pub. Date: Jul. 17, 2014

(54) METHOD FOR PREPARING A POROUS NUCLEAR FUEL

(71) Applicants: Sebastien Picart, Villeneuve Les Avignon (FR); Elodie Remy, Le Pontet (FR); Thibaud Delahaye, Tresques (FR)

(72) Inventors: Sebastien Picart, Villeneuve Les Avignon (FR); Elodie Remy, Le Pontet (FR); Thibaud Delahaye, Tresques (FR)

(73) Assignee: Commissariat a l'energie atomique et aux ene alt, Paris (FR)

(21) Appl. No.: 14/239,614

(22) PCT Filed: Aug. 21, 2012
(86) PCT No.: PCT/EP2012/066284

§ 371 Date: Feb. 19, 2014

(30) Foreign Application Priority Data
Aug. 22, 2011 (FR) 11 57443

(51) Int. Cl. G21C 3/62

(52) U.S. Cl. CPC G21C 3/62
USPC 264/5

(57) ABSTRACT

A method for producing a porous fuel including uranium, optionally plutonium, and optionally at least one minor actinide, the method including: a) compacting a mixture including a first type of agglomerate including uranium oxide in a form of uranium dioxide UO₂, optionally plutonium oxide, and optionally at least one minor actinide oxide, and a second type of agglomerate including uranium oxide in a form of triuranium octaoxide U₃O₈, optionally plutonium oxide, and optionally at least one minor actinide oxide; b) reducing the compacted mixture in a reducing medium, to reduce all or part of the triuranium octaoxide U₃O₈ into uranium dioxide UO₂, the second type of agglomerate being prepared prior to the compacting by a series of specific operations.

### TECHNICAL FIELD

The invention relates to a method for preparing a porous nuclear fuel including uranium, optionally plutonium and optionally at least one minor actinide implementing steps not involving powdery compounds of these elements.

This method may find, in particular, application in the recycling of minor actinides via the incorporation of said minor actinides in the aforementioned fuel, which is intended to be used to constitute nuclear rods for nuclear reactors or to enter into the constitution of transmutation targets, with a view to conducting nuclear transmutation experiments particularly to better understand the mechanism of transmutation of said minor actinide elements.

More generally, this method may find application simply in the manufacture of porous fuels including uranium.

It is pointed out that in the remainder of the description, minor actinide is taken to mean actinide elements other than uranium, plutonium and thorium, formed in the reactors by successive captures of neutrons by the nuclei of standard fuel, the minor actinides being americium, curium and neptunium.

### STATE OF THE PRIOR ART

In operation, pressurised water reactors operating with uranium based fuels generate fission products, some of which are in the form of gas, as well as heavy elements: minor actinides. The latter, formed by successive neutronic captures of the nuclei of the fuel, are mainly isotopes of neptunium, americium and curium. They are the source of a strong a emission and a release of helium gas in important quantity. For reasons of safety, it is thus preferable that new uranium based fuels have intrinsically, due to these phenomena occurring during use or during storage for fuels that integrate, from their manufacture, a non-negligible quantity of minor actinides, a stable level of porosity under irradiation, which enables the evacuation of these fission gases and helium from decay without physical degradation of the fuel.

After use, the fuels comprising minor actinides are presently recycled according to two separate routes known as:
heterogeneous recycling; and
homogeneous recycling.

In the case of heterogeneous recycling, the minor actinides are separated, during the treatment of the spent fuel, from the uranium and plutonium, and are then incorporated, at a higher level, in fertile fuel elements separate from the standard fissile fuel elements of the reactor. The fuel elements comprising minor actinides may consist, for example, of cover elements arranged on the periphery of the core of a reactor. This recycling route makes it possible, in particular, to avoid degrading the characteristics of the core of reactors by non-standard fuels incorporating minor actinides by concentrating the problems of recycling generated by these actinides on a reduced flow of material.

In the case of homogeneous recycling, the minor actinides are mixed, at a low level, and are distributed in a quasi-uniform manner in the totality of the reactor standard fuel elements. To do so, during the treatment of the spent fuel, uranium, plutonium and minor actinides are treated together to form oxides, which are then used in the manufacture of said fuels.

The introduction of minor actinides in fuels intended for the reactor core results, in the same way as for fuels where minor actinides appear during use, in an important emission, within these fuels, of fission gases and in a strong a emission. For safety reasons, it is thus necessary to provide for fuels having a microstructure comprising a stable level of porosity under irradiation, which enables, what is more, the evacuation of fission gases and helium from decay without physical degradation of the fuel. The level of porosity recommended for such fuels must be of the order of 14 to 16%, in the same way as the porosity must be an open porosity, so as to facilitate the release of the helium produced and to avoid the phenomena of swelling of the fuel subsequent to the auto-irradiation induced by the production of minor actinides.

To try to approach or even to attain such a level, it is known to incorporate in the fuel precursor important quantities of organic porogenic agents during the step of mixing/grinding of the aforementioned oxides. Nevertheless, the durability of organic porogenic agents is not assured given the high level of a emission generated by the presence of minor actinides. In fact, the porogenic agents used at present (such as azodicarbonamide) very quickly lose their properties, which can generate an important reject rate that is difficult to manage due to the presence of minor actinides. Hence the impossibility of storing precursor mixtures intended to constitute fuels and, due to the degradation of the porogenic agents, a risk of swelling before fritting of the fuel pellets intended to enter into the constitution of the fuel. Hence the impossibility of obtaining fuels having controlled porosity.

The present inventors have set themselves the aim of proposing a method for preparing a porous fuel including uranium, not having the drawbacks inherent in the use of organic porogenic agents, namely the degradation of these agents as of the stage of mixing of the fuel precursors, this innovative method involving the use of inorganic porogenic agents, which enable, among other things, a control of the porosity, both in quantitative terms and in qualitative terms (particularly in terms of sizes of pores and characteristics of pores).

### DESCRIPTION OF THE INVENTION

Thus, the invention relates to a method for producing a porous fuel including uranium, optionally plutonium, and optionally at least one minor actinide which includes the following series of steps:

a) a step of compacting a mixture including a first type of agglomerate including uranium oxide in the form of uranium dioxide UO₂, optionally plutonium oxide, and optionally at least one minor actinide oxide, and a second type of agglomerate including uranium oxide in the form of triuranium octaoxide U₃O₈, optionally plutonium oxide, and optionally at least one minor actinide oxide;

b) a step of reducing the compacted mixture in a reducing medium, so as to reduce all or part of the triuranium octaoxide U₃O₈ into uranium dioxide UO₂.

The second type of aforementioned agglomerate may be prepared prior to the compacting step a) by a series of specific operations that will be described in greater detail hereafter.

In the remainder of this description, the expressions “first type of agglomerate” or “agglomerates of the first type” and “second type of agglomerate” or “agglomerates of the second type” will be used indiscriminately.

This innovative method has the following advantages:
on account of the use of agglomerate and not powders as such, it does not induce hazards linked to the handling of powders (such as dispersion and volatility), said hazards being all the more important here since the invention is situated in the nuclear field;
it does not involve a step of powder granulation, which makes it possible to reduce the risks of contamination linked to the presence of fine particles generated during such a step;
because the reduction of triuranium octaoxide U₃O₈ is accompanied by a reduction in volume of around 30%, it is possible, by playing on the shape of the agglomerates of the second type, on the quantity of triuranium octaoxide U₃O₈ contained therein and on the proportion of agglomerate of the second type compared to those of the first type, to control the porosity of the fuel obtained following the reduction step, said control being able to have effect in terms of shape of pores, size of pores and quantity of pores.

As mentioned above, the compacting step takes place on a mixture including a first type of agglomerate including uranium oxide in the form of uranium dioxide UO₂, optionally plutonium oxide, and optionally at least one minor actinide oxide, and a second type of agglomerate including uranium oxide in the form of triuranium octaoxide U₃O₈, optionally plutonium oxide, and optionally at least one minor actinide oxide.

Whether for the agglomerates of the first type or of the second type, the minor actinide oxide may be americium oxide, such as AmO₂, Am₂O₃, curium oxide, such as CmO₂, Cm₂O₃, neptunium oxide, such as NpO₂ and mixtures thereof.

Whether for the agglomerates of the first type or of the second type, plutonium oxide may come in the form of PuO₂ and/or Pu₂O₃.

The agglomerates of the first type and the agglomerates of the second type have, advantageously, a spherical shape, this shape being particularly suitable within the scope of the invention, because it enables easy filling of the moulds and a distribution in said moulds, in which may take place the compacting step. When they have a spherical shape, these agglomerates may be qualified as spherules.

The agglomerates of the second type may, in particular, come in the form of spheres having an average diameter above 50 μm, preferably ranging from 100 to 1200 μm.

The compacting step may be carried out using a press, which is going to apply a pressure to the mixture of agglomerate placed in a mould, the shape of which corresponds to the shape that it is wished to allocate to the porous fuel, said shape being conventionally that of a pellet.

The pressure applied is adjusted as a function of the desired microstructure and the dimensions of the agglomerates.

For example, the compacting step may consist in applying to the mixture of agglomerate a pressure that can range from 100 to 1200 MPa, preferably, from 300 to 600 MPa.

Prior to the aforementioned compacting step, the method of the invention may comprise a step of preparing agglomerates of the first type and/or agglomerates of the second type and, in particular, a step of preparing agglomerates of the second type.

Concerning the agglomerates of the second type, these may be prepared, advantageously, by the implementation of the following series of operations:

i) an operation of preparing a charge solution comprising a nitric solution including uranium in the form of a complex of hydroxylated uranyl nitrate and optionally plutonium and/or at least one minor actinide in the form of plutonium nitrate and/or nitrate of at least one minor actinide;

ii) an operation of passing said solution on a cation exchange resin comprising carboxylic groups, said resin being constituted of beads of cation exchange resins comprising carboxylic groups, such that the uranium in uranyl form and optionally plutonium and/or at least one minor actinide in cationic form remain fixed to the resin;

iii) an operation of heat treatment of said resin in a medium comprising oxygen, thereby obtaining the agglomerates of the second type, i.e. more specifically, agglomerates of spherical shape including uranium oxide in the form of triuranium octaoxide U₃O₈, optionally plutonium oxide and optionally at least one minor actinide oxide.

By acting in this way to prepare agglomerates of the second type, the inventors have been able to note, in a surprising manner, that the resulting agglomerates have a conserved spherical shape compared to the initial beads of cation exchange resins, despite an important shrinkage in size by a factor of around 1.5. This property turns out to be particularly interesting, within the scope of the invention, because it makes it possible to control subsequently the porosity of the fuel prepared according to the method of the invention.

As mentioned above, the first operation consists in preparing a charge solution intended to be passed through a cation exchange resin comprising carboxylic groups.

This charge solution, when it only contains uranium in the form of a complex of hydroxylated uranyl, may be prepared by introduction of a predetermined quantity of uranium oxide UO₃ or optionally U₃O₈, in a solution of nitric acid, said quantity being fixed so as to form a complex of hydroxylated uranyl nitrate of formula UO₂(NO₃)₂₋ₓ(OH)ₓ with x≦1, for example a complex of uranyl nitrate hydrolysed to a rate of 25% of formula UO₂(NO₃)_{1.5}(OH)_{0.5}.

This charge solution, when it includes, moreover, plutonium and/or at least one minor actinide in the form of plutonium nitrate (for example, Pu(III)) and/or nitrate of at least one minor actinide, may be prepared in the following manner:
the preparation of a first nitric solution comprising the nitrate of said actinide and/or plutonium element;
the introduction of a predetermined quantity of uranium oxide UO₃ or optionally U₃O₈, in said first solution, said quantity being fixed so as to form a complex of hydroxylated uranyl nitrate of formula UO₂(NO₃)₂₋ₓ(OH)ₓ with x≦1 for example a complex of uranyl nitrate hydrolysed to a rate of 25% of formula UO₂ (NO₃)_{1.5} (OH)_{0.5};
a step of mixing the resulting solution, preferably at ambient temperature, optionally followed by a step of filtration.

According to a variant, the charge solution may be prepared by introduction in a first solution comprising the nitrate of said actinide and/or plutonium element and already uranyl nitrate or nitric acid, of a predetermined quantity of triuranium oxide so as to obtain the desired quantity of uranium and a complex of hydroxylated uranyl nitrate of formula UO₂(NO₃)₂₋ₓ(OH)ₓ with x≦1.

It is important that the uranyl cation is in the form of a complex of hydroxylated uranyl nitrate, because it has been demonstrated that the presence of this complex constitutes the driving force for the exchange between the resin and the cations present in the charge solution. The presence of this complex in the charge solution makes it possible in particular to cause the concomitant ionic exchange of the uranyl cations and actinides and/or plutonium cations with the protons of the cation exchange resins, during the passage of the charge solution thereon.

This predetermined quantity of triuranium oxide to introduce in the first solution is fixed so that the molar ratio between the number of moles of nitrate ions and the number of moles of uranium is less than 2.

As an example, for a complex of uranyl nitrate hydrolysed to a rate of 25% of formula UO₂(NO₃)_{1.5}(OH)_{0.5}, the formation equation of this complex may be the following:

3UO₂(NO₃)₂+UO₃+H₂O→4UO₂(NO₃)_{1.5}(OH)_{0.5}

As an example, to obtain such a complex, starting with a solution of americium nitrate containing a moles of nitric acid, (a/R) moles of uranium oxide could be dissolved, R being the number of moles of nitrates attributed to uranium (i.e. 1.5 here).

The following operation then consists in passing the charge solution through a cation exchange resin comprising carboxylic groups, conventionally coming in the form of a bed of beads of cation exchange resin comprising carboxylic groups, so as to enable the fixation of the uranyl cations and actinides and/or plutonium cations.

The resins used conventionally come in the form of polymer beads integrating exchangeable groups, in our case carboxylates bearing H⁺ protons. The resins used within the scope of the invention may be resins resulting from the (co)polymerisation of (meth)acrylic acid or acrylonitrile with a cross-linking agent, particularly divinylbenzene (DVB).

In the case of acrylonitrile, it will be necessary to provide for, after polymerisation, a step of hydrolysis of the —CN groups into carboxylic groups.

Commercially available resins being able to be used for the implementation of the method of the invention may be resins supplied by Rohm & Haas, such as IMAC HP 335 resins.

The cation exchange resins chosen may be made to undergo one or more treatment steps before passage of the charge solution, among which may be cited:
a step of calibration, by wet method, so as to isolate the desired particle size fraction, for example, a fraction ranging from 600 to 800 μm;
at least one step of washing by implementing a cycle of basic and acid treatment with ammonia solution and nitric acid followed by a step of rinsing with demineralised water;
a step of drying after the rinsing step;
a step of shape sorting, so as to eliminate broken or non-spherical particles, this step being able to be carried out on a tilted table.

It is pointed out that the purpose of the aforementioned washing step is to clean the resin of any presence of synthesis residues. Thus, the fixation of an ammonium group by neutralisation reaction of the proton of the carboxylic groups enables a swelling of the resin favourable to better access of the pores to the washing water. The passage of nitric acid then makes it possible to replace the ammonium groups by H⁺ protons to re-establish the carboxylic groups.

The resin, optionally treated if necessary, is then advantageously thoroughly dampened and placed in a column to form of bed of resin particles intended to receive the charge solution.

The operation of passing the charge solution through the resin conventionally consists in letting it flow, by percolation, through the bed and recovering an eluate at the outlet of the bed. During this passage, the resin comprising carboxylic groups exchanges progressively its protons against the uranyl cations and the cations of the actinide and/or plutonium element. The pH of the eluate drops sharply, when the exchange starts with the resin in proton form (in other words comprising carboxylic groups —COOH). It then rises progressively until the pH value of the input charge is regained, which signifies that the exchange is terminated and that the resin is saturated in metal cations. It is thus possible to stop the passage of the charge solution through the resin. In other words, conventionally, the passage through the resin of the charge solution is carried out until an eluate is obtained having a concentration identical to that of the charge solution.

The eluate recovered in the course of the method may be made to undergo a step of recycling, for example, by adjusting the acidity of said eluate by addition of nitric acid, by dissolving optionally uranium oxide in the solution and completing it with a solution of actinide and/or lanthanide nitrate if necessary, so as to constitute a new charge solution, intended to be passed through the resin.

After the passage operation, an operation of washing the resin with demineralised water may be carried out, particularly with a view to expelling the charge remaining in the pores of the resin.

Before the heat treatment operation, an operation of drying of the resin at a temperature in the region of 100° C., for example at 105° C., may also be carried out so as to bring about the evaporation of the water present in the pores of the resin.

Finally, the resin is subjected to an operation of heat treatment, in a medium comprising oxygen, thereby obtaining agglomerates of spherical shape including uranium oxide in the form of triuranium octaoxide U₃O₈, optionally plutonium oxide and/or an oxide of at least one minor actinide.

This heat treatment operation is conventionally carried out at an efficient temperature and duration to obtain the formation of triuranium octaoxide U₃O₈, optionally plutonium oxide and/or oxide of at least one minor actinide. This efficient temperature and duration may be easily determined by those skilled in the art by simple tests until the desired phases are, obtained, these phases being able to be detected by simple analysis techniques, such as X-ray diffraction.

As an example, this heat treatment operation may be carried out at a temperature ranging from 600 to 1400° C. for a duration ranging from 1 to 6 hours.

Concerning the agglomerates of the first type, they may be prepared by reduction of agglomerate including uranium oxide in the form of triuranium octaoxide U₃O₈ optionally in association with plutonium oxide and one or more oxides of at least one minor actinide, said agglomerates being able to be prepared beforehand by the implementation of a series of operations i), ii) and iii) as defined above.

This reduction may consist in applying to said agglomerates an efficient temperature and duration to obtain agglomerates of the first type, namely agglomerates including uranium oxide in the form of uranium dioxide UO₂, optionally plutonium oxide, and optionally at least one minor actinide oxide. This efficient temperature and duration may be easily determined by those skilled in the art by simple tests until the desired phases are obtained, these phases being able to be detected by simple analysis techniques, such as X-ray diffraction.

As an example, this reduction may be carried out at a temperature ranging from 600 to 1000° C. for a duration ranging from 1 to 12 hours.

The method of the invention may further comprise a step of dry mixing of said agglomerates of the first type and of the second type, this step of dry mixing being implemented before the compacting step and after the potential step of preparing said agglomerates.

Said mixing step consists in placing in contact the agglomerates of the first type and the second type in appropriate proportions as a function of the desired stoichiometry and aims to obtain, in particular, a homogeneous mixture, for example by means of a roller type agitator, a Turbula type mixer or a wrist-action shaker. Said mixing step will be implemented with the necessary care, in order to avoid damaging the agglomerates and particularly breaking them.

Following the method of the invention, the reduction step b) is implemented, which may be carried out by passage of a current comprising a reducing gas at a temperature ranging from 600 to 1000° C. for a duration ranging from 1 to 12 hours, this reduction step having the function of reducing all or part of the triuranium octaoxide U₃O₈ into uranium dioxide UO₂ such that there is concomitant formation of a porosity generated by the reduction in unit cell size between that of U₃O₈ and that of UO₂.

After the reduction step b), a sintering step may be implemented, having the purpose of consolidating the fuel obtained following the method, and particularly to make it denser.

The sintering step may be carried out by heating at a temperature ranging from 1000 to 1900° C. for a duration ranging from 1 to 12 hours.

The aforementioned reduction step and the sintering step may be implemented during a single thermal cycle, the reduction step taking place during the rise in temperature up to 1000° C. whereas the fritting step takes place above 1000° C. (from 1000 to 1900° C. as mentioned above).

Other characteristics will become clearer on reading the complement of the description that follows, which relates to an example for producing a porous fuel according to the invention.

Obviously, the example that follows is only given as an illustration of the subject matter of the invention and does not constitute, in any way, a limitation of said subject matter.

### BRIEF DESCRIPTION OF THE DRAWINGS

FIG. 1 represents a photograph obtained by optical microscopy of spherules of U₃O₈ obtained according to example 1.

FIG. 2 represents a photograph obtained by optical microscopy of spherules of UO₂ obtained according to example 1.

FIG. 3 represents a graph illustrating the thermal cycle applied during the reactive fritting step within the scope of example 1 and the comparative example.

FIG. 4 represents a photograph obtained by optical microscopy of pellets obtained following example 1.

FIG. 5 represents a photograph obtained by optical microscopy of the pellets obtained following the comparative example.

### DETAILED DESCRIPTION OF PARTICULAR EMBODIMENTS

### Example 1

This example illustrates the preparation of a porous fuel of uranium oxide comprising UO₂ according to the method of the invention.

This preparation comprises:
a step of preparing spherules of U₃O₈;
a step of preparing spherules of UO₂;
a step of dry mixing of the spherules of U₃O₈ or of UO₂;
a step of pressing said mixture;
steps of reducing and sintering the mixture thereby pressed.

a) Preparation of Spherules of U₃O₈

Firstly, a charge solution of acid deficient uranyl nitrate is prepared by dissolution up to saturation of 39 g of triuranium oxide UO₃ in 1 L of 260 mM uranyl nitrate solution. After filtration, a solution of uranyl partially hydrolysed and corresponding to the formulation UO₂(NO₃)_{1.3}(OH)_{0.7} is thereby obtained. The final concentration of uranium is 400 mM and the pH value rises to 3.4, which constitutes sufficient conditions for a cationic exchange on a carboxylic resin.

Secondly, this solution prepared beforehand is passed, with a flow rate of 2 mL/min, through a column of 1.8 cm² section comprising a bed of carboxylic type cation exchange resin of IMAC HP 335 type of the firm Dow Chemicals, of particle size fraction 630-800 μm and equivalent to 40 g of dry resin in protonic form.

The cationic exchange is carried out between the uranyl cations UO₂²⁺ and the protons of the resin according to the following equation:

2RH+2.9(UO₂)(NO₃)_{1.3}(OH)_{0.7}→R₂UO₂+2H₂O+1.9(UO₂)(NO₃)₂

(R being an organic unit of the resin).

After stabilisation of the pH of the percolate at 3.4, a resin charged in uranium having a percentage by weight of metal of 43% is thereby obtained. The resin is then dried at 105° C. in a tube furnace for 4 hours.

The resin thereby dried is then subjected to a heat treatment consisting in calcinating it under air at 800° C. for 4 hours with rise in temperature of 1° C./min, such that the resulting product is in the form of spherules, which, after analysis by X-ray diffraction, exhibit the presence of a U₃O₈ phase of orthorhombic structure. These spherules have an average particle diameter, measured by optical microscopy, of 425 μm.

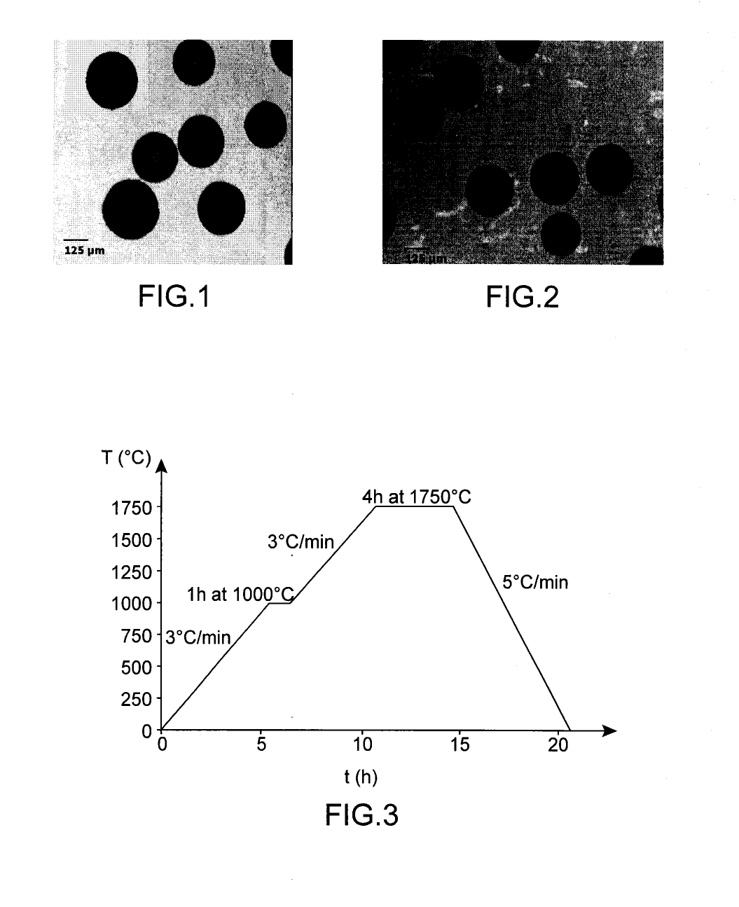

A photograph of these spherules obtained by optical microscopy is represented in FIG. 1.

b) Preparation of Spherules of UO₂

These spherules are prepared from a fraction of U₃O₈ spherules. The latter are subjected to a heat treatment under reducing atmosphere comprising argon and hydrogen (4%) up to 700° C. for 6 hours. Spherules of UO₂ oxides are thereby obtained identified by X-ray diffraction. These spherules have an average particle diameter, measured by optical microscopy, of 380 μm.

A photograph of these spherules obtained by optical microscopy is represented in FIG. 2.

c) Dry Mixing Step

In this step, the dry mixing is carried out of 180 mg of U₃O₈ spherules and 270 mg of UO₂ spherules using a Turbula type mixer for 15 minutes, so as to obtain a homogeneous mixture.

d) Step of Compacting the Mixture

The mixture from step c) is subjected to a compacting at 400 MPa using a three-cup die of 5 mm diameter with lubrication with stearic acid of the matrix and the pistons.

e) Reduction and Sintering Steps

The mixture thereby pressed is subjected to a step of reduction and a step of sintering under argon hydrogenated to 4% according to a thermal cycle illustrated by appended FIG. 3.

The reduction step takes place during the rise in temperature up to 1000° C., whereas the fritting step as such takes place at 1750° C. for 4 hours.

Following these steps, a pellet is obtained having a porosity of the order of 17% by volume (which corresponds to the geometric porosity determined by weighing and measurement of the apparent volume).

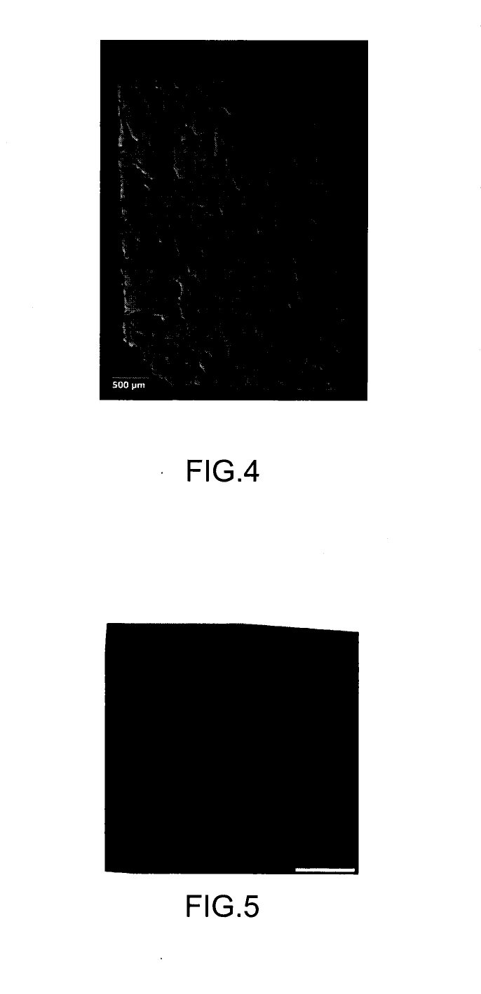

A polished section of the sintered pellet has been observed in the optical microscope (the result of this observation being represented in appended FIG. 4).

The pellet, the geometric density of which attains 83% of the theoretical density of UO₂ has a high level of percolating open porosity and distributed in a homogeneous manner.

### Comparative Example

This example illustrates the preparation of a fuel of uranium oxide UO₂ uniquely from spherules of UO₂.

This preparation comprises:
a step of preparing spherules of UO₂;
a step of pressing the spherules thereby obtained;
a step of sintering the mixture thereby pressed.

a) Preparation of Spherules of UO₂

Firstly, a charge solution of acid deficient uranyl nitrate is prepared by dissolution up to saturation of 39 g of triuranium oxide UO₃ in 1 L of 260 mM uranyl nitrate solution. After filtration, a solution of uranyl partially hydrolysed and corresponding to the formulation UO₂(NO₃)_{1.3}(OH)_{0.7} is thereby obtained. The final concentration of uranium is 400 mM and the pH value rises to 3.4, which constitutes sufficient conditions for a cationic exchange on a protonated carboxylic resin.

Secondly, this solution prepared beforehand is passed, with a flow rate of 2 mL/min, through a column of 1.8 cm² section comprising a bed of carboxylic type cation exchange resin of IMAC HP 335 type of the firm Dow Chemicals, of particle size fraction 630-800 μm and equivalent to 40 g of dry resin in protonic form.

The cationic exchange is carried out between the uranyl cations UO₂²⁺ and the protons of the resin according to the following equation:

2RH+2.9(UO₂)(NO₃)_{1.3}(OH)_{0.7}→R₂UO₂+2H₂O+1.9(UO₂)(NO₃)₂

(R being an organic unit of the resin).

After stabilisation of the pH of the percolate at 3.4, a resin charged with uranium is thereby obtained having a percentage by weight of metal of 43%. The resin is then dried at 105° C. in a tube furnace for 4 hours.

The resin thereby dried is then subjected to a first heat treatment consisting in calcinating it under air at 800° C. for 4 hours with a rise in temperature of 1° C./min, such that the resulting product is in the form of spherules, which, after analysis by X-ray diffraction, exhibit the presence of a U₃O₈ phase of orthorhombic structure. These spherules have an average particle diameter, measured by optical microscopy, of 425 μm.

These spherules thereby prepared are subjected to a second heat treatment under reducing atmosphere comprising argon and hydrogen (4%) up to 700° C. for 6 hours. Spherules of UO₂ oxides are thereby obtained identified by X-ray diffraction. These spherules have an average particle diameter, measured by optical microscopy, of 380 μm.

b) Step of Pressing the Spherules Obtained at Step a)

In this step, the pressing of 700 mg of spherules of UO₂ prepared at the aforementioned step a) is carried out, consisting in applying a pressure of 400 MPa by means of a three-cup die of 5 mm diameter with lubrication with stearic acid of the die and the pistons.

The geometric density of the crude pellet, determined by weighing and measurement of the dimensions (diameter and height measured respectively using a profilometer and a comparator) is estimated at 56% of the theoretical density of uranium oxide UO₂ (which is 10.95 g/cm³ according to the JCPDS 00-041-1422 data sheet).

c) Sintering Step

During this step, the reactive sintering of the crude pellet under hydrogenated argon at 1750° C. for 4 hours is carried out, according to a thermal cycle identical to that of example 1 (this thermal cycle being represented in appended FIG. 3).

Following this sintering, the pellet obtained has a porosity of nearly 7% (this porosity being determined geometrically).

A polished section of the sintered pellet has been observed with an optical microscope (a representation of this observation being illustrated in appended FIG. 5).

The pellet, the geometric density of which attains 93% of the theoretical density of UO₂, has a low level of porosity.

1-11. (canceled)

12. A method for producing a porous fuel including uranium, optionally plutonium, and optionally at least one minor actinide, the method comprising:
a) compacting a mixture including a first type of agglomerate including uranium oxide in a form of uranium dioxide UO₂, optionally plutonium oxide, and optionally at least one minor actinide oxide, and a second type of agglomerate including uranium oxide in a form of triuranium octaoxide U₃O₈, optionally plutonium oxide, and optionally at least one minor actinide oxide;
b) reducing the compacted mixture in a reducing medium, to reduce all or part of the triuranium octaoxide U₃O₈ into uranium dioxide UO₂;
wherein the agglomerates of the second type are prepared prior to the compacting by operations including:
i) an operation of preparing a charge solution including a nitric solution including uranium in a form of a complex of hydroxylated uranyl nitrate and optionally plutonium and/or at least one minor actinide in a form of plutonium nitrate and/or nitrate of at least one minor actinide;
ii) an operation of passing the solution through a cation exchange resin including carboxylic groups, the resin being constituted of beads of cation exchange resin including carboxylic groups, such that the uranium in uranyl form and optionally plutonium and/or at least one minor actinide in cationic form remain fixed to the resin;
iii) an operation of heat treatment of the resin in a medium including oxygen, thereby obtaining the agglomerates of the second type.

13. A method for producing a porous fuel according to claim 12,
wherein the agglomerates of the first type have a spherical shape.

14. A method for producing a fuel according to claim 12, wherein the agglomerates of the second type have a spherical shape.

15. A method for producing a fuel according to claim 12, wherein the agglomerates of the first type are prepared prior to the compacting.

16. A method for preparing a fuel according to claim 15, wherein the agglomerates of the first type are prepared by reduction of agglomerate including uranium oxide in a form of triuranium octaoxide U₃O₈ optionally in association with plutonium oxide and optionally one or more oxides of at least one minor actinide.

17. A method according to claim 16, wherein the agglomerates including uranium oxide in a form of triuranium octaoxide U₃O₈ optionally in association with plutonium oxide and one or more oxides of at least one minor actinide are derived from operations i), ii), and iii).

18. A method according to claim 12, wherein the agglomerates of the second type are in a form of spheres having an average diameter above 50 μm, or ranging from 100 to 1200 μm.

19. A method according to claim 12, further comprising dry mixing the agglomerates of the first type and of the second type, the dry mixing being implemented before the compacting.

20. A method according to claim 12, wherein the reduction b) is carried out by passage of a current comprising a reducing gas at a temperature ranging from 600 to 1000° C. for a duration ranging from 1 to 12 hours.

21. A method according to claim 12, further comprising, after b), a sintering.

22. A method according to claim 21, wherein the sintering is carried out by heating at a temperature ranging from 1000 to 1900° C. for a duration ranging from 1 to 12 hours.
